(19) United States
(12) Patent Application Publication
(10) Pub. No.: US 2005/0156522 A1
(43) Pub. Date: Jul. 21, 2005

(54) Method of manufacturing barrier ribs for pdp by etching of thick film using water-based solution and compositions therefor

(76) Inventors: Yong Seog Kim, Seoul (KR); Jin Ha Hwang, Seoul (KR); Yong Ho Kim, Seoul (KR)

Correspondence Address: BIRCH STEWART KOLASCH & BIRCH, PO BOX 747, FALLS CHURCH, VA, 22040-0747, US

(21) Appl. No.: 10/510,036

(22) PCT Filed: Apr. 8, 2002
(86) PCT No.: PCT/KR02/00612

(30) Foreign Application Priority Data
Apr. 4, 2002 (KR) 2002/18720

(51) Int. Cl. H01J 17/49

(52) U.S. Cl. 313/582; 313/586

(57) ABSTRACT

Disclosed is a method of manufacturing barrier ribs for a Plasma Display Panel (PDP), which includes the steps of forming a thick film (or, “green tape”) for barrier ribs on a glass or metal substrate by using composition for forming the barrier ribs, which contains water soluble components and solvent soluble components together a binder; forming a protective pattern film partially soluble or insoluble to the water based solution on the thick film; etching the thick film into a barrier rib shape by using solution or mixed solution containing ceramic powder as an etching accelerator, and sintering the etched thick film. This method causes rare environmental pollution, enables to make barrier ribs having fine and complex shapes and reduces material costs required for the barrier rib. Thus, the method may improve quality of DPD and reduce manufacture costs of the rear plate.

### TECHNICAL FIELD

The present invention relates to a method of manufacturing barrier ribs for a rear plate of a Plasma Display Panel (PDP) by etching in an unfired state using water-based solution and composition used for the method, and more particularly to a method of manufacturing barrier ribs by forming a thick film for barrier ribs using composition containing a binder composed of water soluble components and solvent soluble components and then etching the thick film using water-based solution.

### BACKGROUND ART

A Plasma Display Panal (PDP) is a flat display panel, which is mainly used for large-sized display devices over 40 inches because the PDP is thin and light and offers good images quality. In the PDP, pixels are formed at the position where barrier ribs and address electrodes formed on a rear plate intersect sustain electrodes formed on a front plate to display an image. The PDP is schematically shown in FIG. 1. Referring to FIG. 1, a dielectric layer 9 is coated on a rear plate 8 made of a glass or metal substrate, and address electrodes 5 are formed on the lower plate 5 or the dielectric layer 9. Barrier ribs 6 having a long stripe shape are positioned between the address electrodes 5, and fluorescent material is coated on the surface between the barrier ribs 6 in order to compose a sub-pixel. A sustain electrode 4 is embedded in a front plate 1 made of glass, and a dielectreic layer 2 and an MgO protective layer 3 are provided below the sustain electrode 4. Thus, when the front plate 1 is combined with the rear plate 9, there generates a plurality of pixel spaces separated by the barrier ribs 6. These separated spaces are filled with He/Xe gas or Ne/Xe gas so as to create plasma therein when voltage is applied to the sustain electrode 4 and the address electrode 5. Subsequently, vacuum ultra violet generated from the plasma excites the fluorescent material coated on the side walls of the barrier ribs and bottom surfaces between the barrier ribs, thereby creating red, green and blue visible light.

In order to form the barrier ribs, the sand blasting is mainly used. FIG. 2 schematically shows sequential processes of the sand blasting. As proposed in Japanese Patent serial No. 11-120905 and Korean Patent application No. 2000-10322 in detail, the sand blasting is executed according to the following procedure: coating paste containing glass powder for barrier rib and a ceramic filler on a rear plate such as a glass board and then drying, which is repeated several times until to have a thickness of about 200 μm, coating photoresist on the dried thick film; and developing the film except portions corresponding to the barrier ribs to be removed. At this time, the exposed portion is determined depending on the type of the photoresist film. And then, ceramic powder such as calcium carbonate (CaCO₃) is sprayed together with high pressed air onto the film coated with photoresist in order to etch the portions where the photoresist is removed, thereby forming the barriers ribs.

The sand blasting is relatively stable and thus frequently used to make the barrier ribs of the existing PDP. However, the sand blasting has drawbacks in that complicated processes are required to manufacture the barrier ribs, the side walls of the manufactured barrier ribs are not uniform, and the drying and coating process is executed very slowly.

Recently, as the picture definition of the PDP improves, the pitch of the sub-pixel between the barrier ribs is decreased from 420 μm to 200 μm, which needs a method for making a barrier rib having a thickness less than 50 μm. In case the pitch of the sub-pixel is 200 μm and the thickness of the barrier rib is 50 μm, the open ratio becomes 50%, while in case the cell pitch is 100 μm, the open ratio becomes 0%, and thereby it is impossible to compose the display panel. Thus, it is required that the barrier rib has a thickness between 20 μm and 30 μm. However, the sand blasting is substantially impossible to obtain such thickness. Since ceramic powder and high-pressure gas are used for etching to form the barrier ribs, it is hardly possible to make a thin barrier rib since the barrier rib is broken due to the mechanical energy of the ceramic powder and the high-pressure gas. In addition, if the pitch of the sub-pixel is 430 μm and the width of the barrier rib is 50 μm during the manufacture of the barrier ribs using the sand blasting, at maximum 90% of the volume of the thick film is etched and removed. Thus, the sand blasting generates a large amount of wastes. Furthermore, glass frit of the thick film containing a large amount of lead monoxide may cause environmental pollution.

As another example, a method for forming barrier ribs by etching the fired glass {SID 01 Digest, p537(2001)}. This method is now briefly described. At first, a thick film having a predetermined thickness is formed on a glass substrate by using the paste including glass powder and ceramic powder. The thick film may be formed by using the well-known printing and drying process repeatedly, or by lamination using a dry film. After the thick film is formed, the thick film is heated up to a predetermined temperature with a predetermined temperature profile, and then to make a thick film. A photosensitive film is coated or laminated on the surface of the fired thick film, and then the photosensitive film is selectively exposed to light with a mask. The exposed specimen is developed to form an etching protective pattern film of the photosensitive film, and then the exposed thick film is etched by suitable etchant. And then, through washing and drying processes, barrier ribs for PDP are finally manufactured. This method may advantageously make a barrier rib having fine and complex shape since it does not require the etching process using mechanical impacts. However, the dense glass thick film is generally slowly etched, particularly experiencing the isotropic-etching. Thus, Photonics Co. provides a method for improving a barrier rib forming speed by etching a porous thick film {SID 01 Digest, p532(2001)}.

Such a etching method has some problems as follows. First, since the fires barrier rib material layer is etched by an etching solution such as acid, environmental pollution may be caused by wasted water. Since the layer to be etched is thick as much as 120 μm˜150 μm, an amount of the wasted water is very significant, thereby requiring much costs for treating the wasted water. Second, physical features required for the barrier rib material such as electric resistance, dielectric constant, thermal expansion coefficient and reflectivity should be satisfied, and the material should be rapidly etched by the water-based solution. Thus, there are many limitations in selecting the material, and thus the selection of the barrier rib material is very limited. Finally, when applied to a large area, this etching method may hardly obtain a uniform etching speed. In other words, in order to have a uniform etching speed throughout the large area and give a desired shape for the barrier rib of the PDP, the etching conditions should be maintained very accurately. However, to maintain the conditions throughout the large area is very hard, thereby resulting in very low process yield.

### DISCLOSURE OF INVENTION

The present invention is designed to solve problems of the prior art by one effort and achieving technical objects desired up to now, as described below.

Firstly, the present invention is directed to prevent dust generation caused by the sand blasting in addition to mechanical damage of barrier ribs by etching the thick film for forming the barrier ribs with the use of water-based solution.

Second, the present invention is directed prevent environmental pollution, which may be generated during forming the barrier rib, by providing a pollution-free mechanical-chemical etching.

Third, the present invention is directed to provide a process of manufacturing barrier ribs, which may be applied to the products such as HDTV requiring the fine pitch barrier ribs.

Fourth, the present invention is directed to improve productivity and quality in manufacturing a thick film for barrier ribs in case of forming the thick film for barrier ribs by laminating a dry film (or, a green tape) on such as a glass substrate.

In order to accomplish the above objects, the present invention provides a method of manufacturing barrier ribs for a Plasma Display Panel (PDP) comprising the steps of: forming a thick film (or, “green tape”) for barrier ribs on a glass or metal substrate by using composition for forming the barrier ribs, which contains water soluble components and solvent soluble components together as a binder; forming a protective pattern film partially soluble or insoluble to the water based solution on the thick film; etching the thick film into a barrier rib shape by using solution or mixed solution containing ceramic powder as an etching accelerator; and sintering the etched thick film.

Preferably, the method includes the steps of: (1) making a slurry by mixing glass powder and ceramic powder so that a mixing ratio is in the range between 50:50 and 95:5(volume ratio), and then mixing 20 to 40 wt % of binder including water soluble components and solvent soluble components, 3 to 18 wt % of plasticizer and 0.5 to 2 wt % of dispersion agent and defoaming agent on the basis of 100 wt % of the mixed powder; (2) making a thick film by coating the slurry on the glass or metal rear plate in the thickness of 5 to 200 μm, and then drying the coated slurry naturally or artificially under a predetermined temperature profile condition; (3) forming the etching protective pattern film partially soluble or insoluble to etching solution through printing or exposure, development and printing on the thick film formed on the glass or metal substrate; (4) etching the thick film on which the protective pattern film is formed into a barrier rib shape by water spraying the solution or the mixed solution in which the ceramic powder is included as etching accelerator; and (5) removing the protective pattern film and then sintering the specimen at 450° C. to 600° C. for 0.5 to 1 hour.

According to another aspect of the invention, there is also provided composition for manufacturing barrier ribs for a Plasma Display Panel (PDP), which includes (a) 100 wt % of mixture of glass powder and ceramic powder of which a volume ratio is in the range of 50:50 to 95:5; (b) 20 to 40 wt % of solvent; (c) 2 to 12 wt % of binder including water soluble components and solvent soluble components together; (d) 3 to 18 wt % of plasticizer; and (e) 0.5 to 2 wt % of dispersion agent and/or defoaming agent.

According to still another aspect of the invention, there is also provided a Plasma Display Panel (PDP) using the barrier ribs manufactured according to the above method.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a perspective sectional view schematically showing a Plasma Display Panel (PDP);

FIG. 2 is a schematic view for illustrating the process for coating a film by using a Doctor blade tape casting device;

FIG. 3 is a schematic view for illustrating the process for manufacturing barrier ribs by using the sand blasting;

FIG. 4 is a schematic view for partially illustrating the process for manufacturing barrier ribs according to an embodiment of the present invention;

FIG. 5 is a graph showing an etching speed depending on a pressure of water-based solution according to the manufacturing method of the present invention;

FIG. 6 is a graph showing an etching speed depending on a flow rate and a nozzle size according to the manufacturing method of the present invention;

FIG. 7 is a picture photographed by the scanning electron microscope for showing a section of the barrier rib manufactured according to the first embodiment; and

FIG. 8 is a picture photographed by the scanning electron microscope for showing a section of the barrier rib manufactured according to the second embodiment.

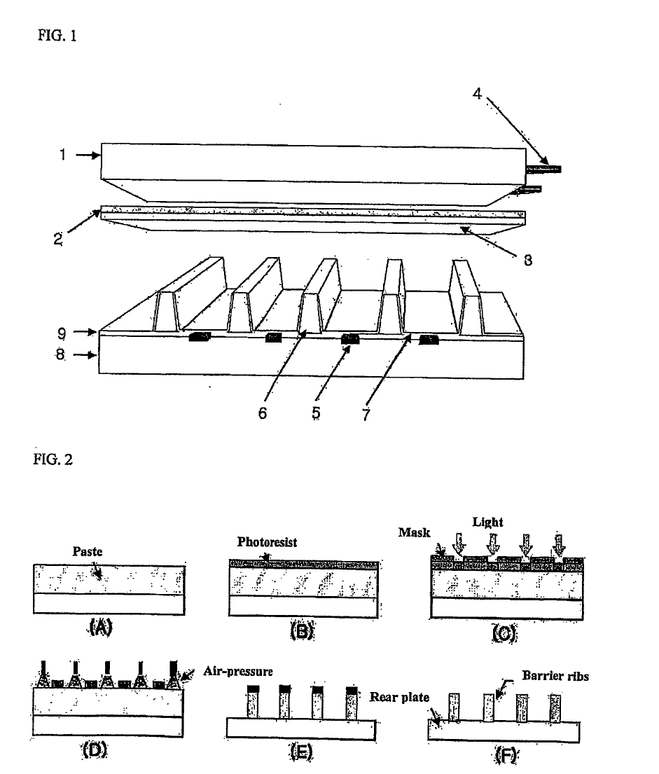

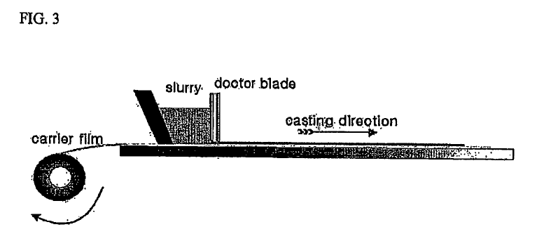

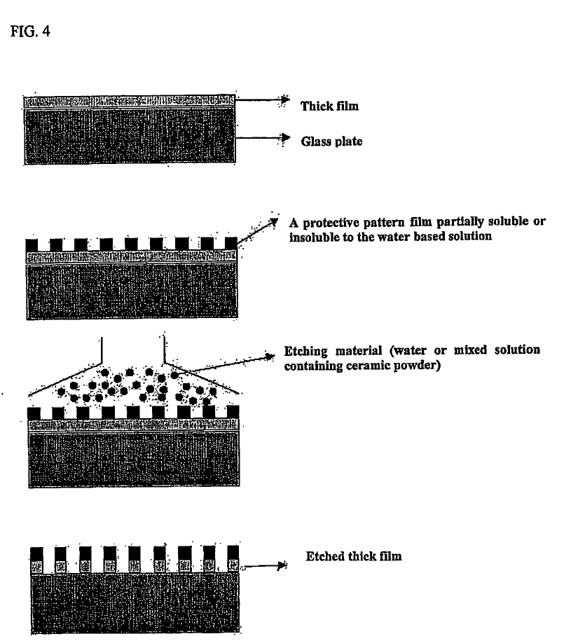

### BEST MODES FOR CARRYING OUT THE INVENTION

Hereinafter, preferred embodiments of the present invention will be described in detail with reference to the accompanying drawings.

A method of manufacturing barrier ribs for a Plasma Display Panel (PDP) according to the present invention includes the steps of: forming a thick film (or, “green tape”) for barrier ribs on a glass or metal substrate by using composition for forming the barrier ribs, which contains water based components and solvent soluble components together as a binder; forming a protective pattern film partially soluble or insoluble to the water soluble solution on the thick film; etching the thick film into a barrier rib shape by using solution or mixed solution containing ceramic powder as an etching accelerator; and sintering the etched thick film.

One of the characteristics of the present invention is that the chemical etching for dissolving the water soluble components in the thick film into the solution is executed together with the mechanical etching for removing the chemically etched thick film by means of mechanical energy of the sprayed solution, thereby making the barrier ribs having a high width-length ratio and an excellent etched shape. In other words, the method for manufacturing barrier ribs for PDP according to the present invention suggests a new concept in the etching process, namely “chemical-mechanical etching method” which have never been reported.

To describe the method for manufacturing barrier ribs according to the present invention in more detail, the method preferably includes the following processes.

(1) a slurry is made by mixing glass powder and ceramic powder so that a mixing ratio is in the range between 50:50 and 95:5(volume ratio), and then mixing 20 to 40 wt % of solvent, 2 to 12 wt % of binder including water soluble components and solvent soluble components, 3 to 18 wt % of plasticizer and 0.5 to 2 wt % of dispersion agent and defoaming agent on the basis of 100 wt % of the mixed powder;

(2) a thick film is made by coating the slurry on the glass or metal lower plate in the thickness of 5 to 200 μm, and then drying the coated slurry naturally or artificially under a predetermined temperature profile condition;

(3) the etching protective pattern film partially soluble or insoluble to the etching solution is formed through printing or exposure, development and printing on the thick film formed on the glass or metal substrate;

(4) the thick film on which the protective pattern film is formed is etched into a barrier rib shape by water-spraying the solution or the mixed solution in which the ceramic powder is included as etching accelerator; and

(5) the protective pattern film is removed and then the specimen is sintered at 450° C. to 600° C. for 0.5 to 1 hour to manufacture the barrier ribs for PDP.

In some cases, in the step (2), it is possible to make the green tape by coating the slurry on a polymer carrier film in the thickness of 5 to 200 μm and then drying the coated slurry naturally or artificially under a predetermined temperature profile condition; and then make the thick film for barrier rib by laminating the green tape, formed on the polymer carrier film, on the glass or metal substrate.

Thus, the terms used in this specification and claims “green tape” and “thick film” are used with the same concept when the slurry is directly applied to the glass or metal substrate used as a substrate of PDP. Though the terms have different meanings when the slurry is moved to the glass or metal substrate after being applied on a polymer carrier film, it should be understood that each of the terms does not have different meanings but designate a substantially identical object.

In addition, an amount of each component of the composition defined in this specification is in the range which is generally receivable in the art related to the composition for forming barrier ribs of PDP. Without any special explanation, the range shows a minimum value and a maximum value suitable for the barrier rib forming composition. In the same reason, set conditions such as thickness of the barrier rib, reaction temperature and reaction time in the manufacturing method are also defined in the range which is receivable for optimized practice.

The slurry making process of the step (1) mixes the components by using the well-known ball mill. In order to optimize the functions of the added components, the slurry making process is conducted by two mixing stages.

At first, glass powder and ceramic powder is put into a ball mill container (or, PP film-Nalgen bottle) as much as much as 20 to 30% of the volume of the PP film-Nalgen bottle, and then 20 to 40 wt % of solvent is added on the basis of 100 wt % of the mixed powder. And then, dispersion agent and lubricant of the above-mentioned amount are added thereto, and then ball-milled. The milling is executed for 1 to 24 hours depending on the agglomeration level of the powder, preferably 6 to 12 hours as a first milling.

If the first milling is completed, binder and plasticizer of the above-mentioned amount are added thereto, and the ball-milled again as a second milling. The second milling is also executed for 1 to 48 hours, preferably 12 to 24 hours.

As for the coating process of the step (2), the slurry is coated on a carrier film such as a miler film or the rear plated glass substrate for PDP by using the doctor blade tape casting as shown in FIG. 3. For the coating process, it is possible to use the die casting, the comma casting, the screen printing and so on in addition to the doctor blade tape casting, and also the die coating and the roll coating are also possible. As described above, the slurry may be shaped on a separate polymer film substrate and then bonded thereon by pressing or lamination.

In the step (3), the etching protective pattern formed on the thick film is printed in a barrier rib pattern by using a solvent soluble paste, which has very low solubility to the solution used as an etching liquid, or by laminating DFR (Dry Film photoResist) on the thick film and the passing through exposure, development and printing. This protective pattern is make of material not dissolved in the solution and having mechanical strength to some extent to give strong resistance against the spraying pressure of the solution or the abrasive action of the ceramic particles added to the mixed solution. The solvent soluble paste may adopt an existing paste for forming barrier ribs. Particularly, the past for black matrix used for improving contrast of PDP may be used in the printing. This printing advantageously gives high productivity and requires low manufacture costs but disadvantageously shows low accuracy of patterns. Thus, in order to manufacture the fine pitch barrier ribs, DFR used for the sand blasting protective pattern film is preferably used. This protective pattern film may be formed in the same way as the method for forming the sand blasting protective pattern film.

In the step (4), solution or mixed solution including ceramic powder as etching accelerator is sprayed on the thick film on which the protective pattern film is formed in order to etch the thick film in a barrier rib shape. In this step, the water soluble components in the binder are dissolved in the etching liquid, which is solution, thereby forming porous structure. In addition, the thick film having the porous structure is removed by using mechanical energy of the sprayed solution or mixed solution. As explained above, since using the chemical etching for dissolving the water soluble components of the binder into the solution together with the mechanical etching using mechanical energy of the sprayed solution, it is possible to make the barrier ribs having a high width-length ratio and an excellent etched shape.

In order to improve the chemical etching speed of the thick film by the solution, surfactant and wetting agent may be preferably added to the solution.

The surfactant is not limited to any special example, but may be preferably selected from alkyl benzene, Di-iso butyl ketone, dipentene, methoxy propyl acetate, xylenes, butyl glycol, cyclohexanol and so on. The wetting agent is not limited to any specific example, but may be selected from tri-methoxy silane, 3-aminopropyl trimethoxy silane, 3-glycidoxypropyl trimethoxy silane and so on. Each of the surfactant and the wetting agent may adopt one compound among the above examples or a mixture having at least two compounds among them. An added amount of the surfactant is 0.5 to 10 wt % on the basis of the water which is solvent. An added amount of the wetting agent is 0.5 to 10 wt % on the basis of the water which is solvent.

In order to increase the mechanical etching speed of the thick film by the solution, ceramic powder of such as alumina, zirxonia, silicon carbide and silicon nitride may be added. The added ceramic powder has an average particle size in the range of 0.1 to 10 μm, and preferably has an angled shape to improve the etching efficiency. An added amount of the ceramic powder is preferably in the range of 0 to 30% on the basis of volume of the water.

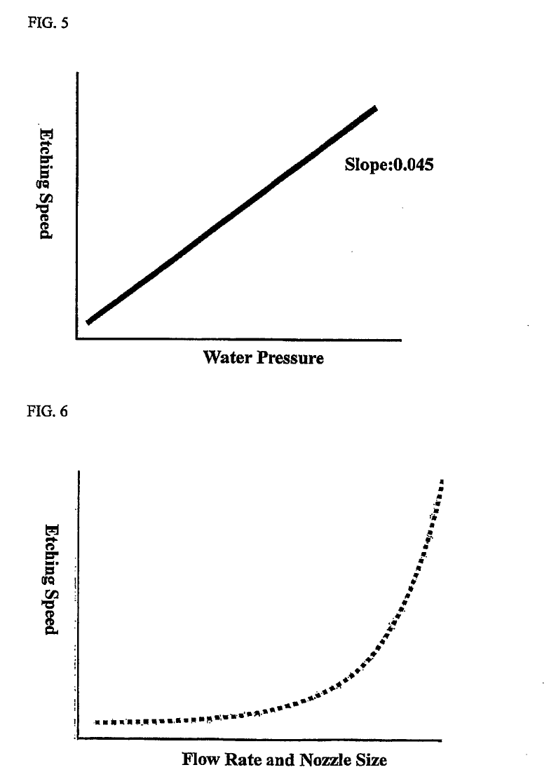

The etching speed of the thick film by the solution is affected by many factors such as solution temperature, pressure, flow rate, spraying angle of the solution, shape of the spraying nozzle and scanning speed. Among these factors, the effect of the solution pressure on the etching speed is illustrated in FIG. 5 As shown in FIG. 5, the etching speed of the solution is substantially linearly increased according to the spraying pressure of the solution. On the while, the flow rate of the solution increases the etching speed of the thick film in the way of exponential function, as shown in FIG. 6. To obtain a suitable barrier rib shape, it is required to adjust these factors appropriately.

The present invention also proposes composition for forming barrier ribs which may be used in the above-mentioned manufacturing method.

The composition for forming barrier ribs according to the present invention includes the following components.

(a) 100 wt % of mixture of glass powder and ceramic powder of which a volume ratio is in the range of 50:50 to 95:5;

(b) 20 to 40 wt % of solvent;

(c) 2 to 12 wt % of binder including water soluble components and solvent soluble components together;

(d) 3 to 18 wt % of plasticizer; and

(e) 0.5 to 2 wt % of dispersion agent and/or defoaming agent.

This composition is coated on the rear plate of PDP or laminated thereon in a green tape shape to form a thick film having a thickness of 5 to 200 μm. And then, after a protective pattern film for etching is formed on the thick film, the thick film is etched into a barrier rib shape having a height in the range of 100 to 200 μm by the solution or the mixed solution which is an etching liquid.

The glass powder is a main component for forming the barrier ribs by plasticity, and has an average particle size of 0.1 to 10 μm. As representative examples, the glass powder may adopt PbO—B₂O₃—SiO₂, P₂O₅—B₂O₃—SiO₂ and Bi₂O₃—B₂O₃—SiO₂ or their mixtures.

The ceramic powder is a filling component which is sintered together with the glass for improving strength and hardness of the barrier ribs. The ceramic powder may adopt Al₂O₃, fused silica, TiO₂ and ZnO₂, or their mixture, which has an average particle size of 1 to 10 μm.

The solvent is a component playing a role of dissolving organic additives such as organic binder and plasticizer in order to give suitable viscosity to the tape casting. The solvent preferably has low boiling point and low viscosity. As representative examples, methyl ethyl ketone (MEK), ethyl alcohol, isopropyl alcohol, toluene, xylene. tri-chloro ethylene, butanol, methanol, acetone, cyclohexanol, nitro-propane, propanol, N-propanol and water may be used alone or in mixed state.

The binder has significantly different feature to the composition of the generally used thick film. A binder in the thick film is generally used as a component acting as a film forming agent so that the film has suitable strength after the slurry is dried. However, the binder used in the present invention should be dissolved at a suitable speed into the solution which is an etching liquid and keep strength so that the barrier ribs may maintain their shape during the etching process, in addition to the traditional role. In order to be etched by the solution, the binder should have water soluble components, namely water soluble binder characteristic.

However, since most of water soluble binders are rapidly absorbed in the water, their strength is abruptly lowered when the water soluble binders come in contact with the solution during the etching process, thereby causing collapse of the etched portion. As a result, it is very hard to satisfy these requirements by using a binder having only one characteristic. Thus, in the present invention, two or more binders including water soluble components and solvent soluble components are mixed.

As for the water soluble binder, one of polyvinyl alcohol (PVA), hydroxyethyl cellulose (HEC), polyvinyl acetate (PVAc), polyvinyl pyrrolidine (PVP), methyl cellulose (MC), hydroxypropylmethyl cellulose (HPMC), polypropylene carbonate, waxes, emulsion and latex, or their mixture may be used. The water soluble binder preferably has an average molecular weight of 5,000 to 300,000.

As for the solvent soluble binder, one of cellulose, ethyl cellulose (EC), polyvinyl butyral (PVB), polymethyl methacrylate (PMMA), polyacrylate ester, polyvinyl pyrrolidine (PVP), polyvinyl chloride, polyethylene, polytetraflouroethylene (PTFE), poly-α -methyl styrene, polyisobutylene, polyurethane, nitro-cellulose and methyl methacrylate, or their mixture may be used. The solvent soluble binder preferably has an average molecular weight of 5,000 to 300,000.

An added amount of the binder is in the range of 2 to 12 wt % on the basis of 100 wt % of the mixed powder, more preferably in the range of 3 to 8 wt %. The binder preferably uses a mixture of the water soluble binder and the solvent soluble binder as described above. A mixed ratio of the water soluble binder and the solvent soluble binder is in the range of 20:1 to 1:20 on the basis of volume, preferably in the range of 10:1 to 1:10.

In some cases, it is also possible to use only the water soluble binder and then etch a thick film containing the water soluble binder by solution after semi-cross-linking the thick film so that the thick film has tolerance to some degree. However, a finally-obtained barrier rib shape of this thick film is more deteriorative than the case of using both water soluble binder and solvent soluble binder. Particularly, since the thick film containing only the water soluble binder requires a separate semi-cross-linking process, the manufacturing procedure of barrier ribs is lengthened and the manufacture costs increase.

The plasticizer is a component which affects on the glass transition temperature and thus acts for controlling thermoplasticity. As representative examples, the plasticizer may adopt diethyl oxalate, polyethylene, polyethylene glycol (PEG), dimethyl phthalate (DMP), dibutyl phthalate (DBP), dioctyl phthalate (DOP), butyl benzyl phthalate, polyalkylene glycols, polypropylene glycol (PPG), tri-ethylene glycol, propylene carbonate, water and butyl stearate, or their mixture.

For example, in case cellulose polymer is used as the binder, diethyl oxalate is preferably used as the plasticizer. In addition, in case PVB or PMMA polymer is used as the binder, it is particularly preferred that the plasticizer adopts PEG, DMP, DBP and DOP. Furthermore, in case the water soluble binder is emulsion or latex, the plasticizer preferably adopts waxes or oil, which is not reacted with the water soluble binder.

An added amount of the plasticizer is preferably in the range of 3 to 18 wt % on the basis of 100 wt % of the mixed powder, and more preferably in the range of 6 to 10 wt %. The content of the additive changes depending on the particle size of the mixed powder. In other words, as the particle size of the powder is smaller, the added amount of the additive increases.

The dispersion agent is a component acting for maintaining the glass powder and the ceramic powder to be mutually dispersed in the slurry. As representative examples, one of menhaden fish oil, polyethyleneimine, glyceryl trioleate, polyacrylic acid, corn oil, polyisobutylene, linoleic acid, stearic acid, ammonium salt, salt acrylic acid, salt of poly acrylic acids, salt of methacrylic acids, linseed oil, glycerol triolate, sodium silicate, dibutylamine, ethoxylate, phosphate ester and 4,5-dihydroxy-1,3-benzenedisulfonic acid (Tiron), or their mixture may be used for the dispersion agent.

The defoaming agent plays a role of changing the surface characteristic of the glass powder and the ceramic powder and reducing the interfacial tension of the solvent to remove foams. Stabilization of foams may be generally controlled by static electricity characteristic out of particles in the aqueous solvent system. The defoaming agent is identical to the dispersion agent in most cases, so compounds related to the defoaming agent are not described in detail.

Organic matters in the composition of the present invention are resolved below the plasticizing temperature of the barrier ribs, and thus do not affect on the sintering density with giving an appropriate viscosity range during the tape casting, thereby giving suitable viscosity in the thickness range, namely 5 to 200 μm, of the green tape required for making the rear plate of DP.

In addition to the essential components, other components for reinforcing the barrier ribs and contributing to the convenience of process may be added to the composition of the present invention if they do not deteriorate the properties of the composition. In addition, other additional processes may be used without damaging the intension of the present invention.

The present invention also provides PDP (Plasma Display Panel) manufactured by using the rear plate on which the above-mentioned barrier ribs are formed. The method for making PDP by using the rear plate on which the above-mentioned barrier ribs is well known in the art, and not described in detail.

Now, more concrete examples of the present invention are described with reference to the above-described embodiments, but the scope of the invention is not limited to the following examples of course.

### EMBODIMENT 1

100 g of powder including glass powder and alumina powder in the ratio of 8:2 is well mixed and then ball-milled for 25 hours. To this powder mixture, 23 g of water as solvent, 0.75 g of ammonium salt poly acrylic acid as dispersion agent, 9 g of hydroxy ethyl cellulose (HEC) and 0.3 g of acrylic emulsion as binder, polyethylene glycol (PEG) as plasticizer, 0.3 g of BYD-024 (manufactured by BYK-Chemie Co.) as defoaming agent, and 0.3 g of BYK-346 (manufactured by BYK-Chemie Co.) as surface controller are additionally mixed and then ball-milled again for 24 hours to make composition for manufacturing barrier ribs of the PDP lower plate.

The composition slurry made in this way is coated on a miler film in the thickness of 180 μm by using the doctor blade tape casting, and then dried at 25° C. for 24 hours to make a green tape.

The obtained green tape is laminated by pressuring a glass substrate on which a back dielectric and an electrode are printed, in order to make a thick film for manufacturing barrier ribs. And then, an etching protective film having a stripe pattern is printed on the thick film in a thickness of 40 μm, a width of 100 μm and a pitch of 420 μm by using a screen printing device. This protective film is coated by using the black paste (Okuno, Japan) for the sand blasting which is a non-aqueous paste basically having no solubility to water.

Then, water is sprayed through nozzles at a pressure of 5 kgf and a flow rate of 1 ml/sec for about 8 minutes onto the thick film on which the pattern protective film in order to etch the thick film into a barrier rib shape. And then, the thick film is sintered at 570° C. for 30 minutes to make the barrier ribs.

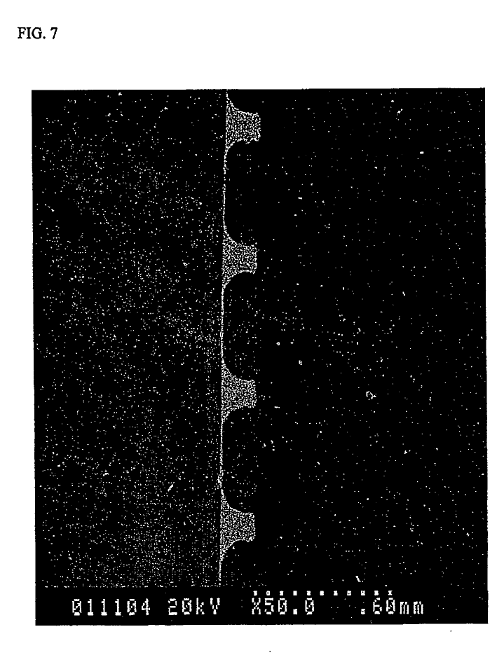

The barrier ribs are then observed by using a scanning electron microscope in order to check that a desired barrier rib is formed on the thick film on the glass substrate. As a result of the observation, it is found that the barrier ribs are formed to have an average height of 127 μm and an average thickness of 80 μm, as shown in FIG. 7.

### EMBODIMENT 2

Barrier ribs are manufactured in the same way as the first embodiment, except that the composition for manufacturing barrier ribs contains components as seen in the following Table 1.

TABLE 1

| | Compound | Content (g) |
|---|---|---|
| Solvent | N-propanol/methanol | 18 |
| | (mixture in a ratio of 1:1) | |
| Dispersion agent | BYK-110 | 2 |
| Water soluble binder | polyvinyl pyrrolidine | 9 |
| Solvent soluble binder | methyl methacrylate | 0.3 |
| Plasticizer | polyethylene glycol | 6 |
| Defoaming agent | BYK-024 | 0.3 |
| Dispersion agent | BYK-346 | 0.3 |

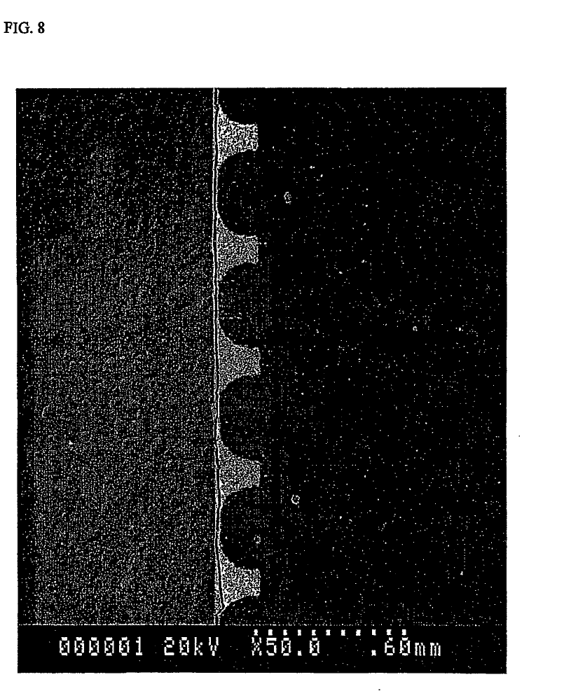

The barrier ribs are then observed by using a scanning electron microscope in order to check that a desired barrier rib is formed on the thick film on the glass substrate. As a result of the observation, it is found that the barrier ribs are formed to have an average height of 140 μm and an average thickness of 80 μm, as shown in FIG. 8.

### COMPARATIVE EXAMPLE 1

Barrier ribs are formed by using composition including components as suggested in the following Table 2 through the same way as the first embodiment. This comparative example 1 is different from the first embodiment just in the point that polyvinyl alcohol which is water soluble binder is uniquely used as the binder.

As a result of checking the shape of the obtained barrier ribs through a scanning electron microscope, it is found that many barriers are broken.

TABLE 2

| | Compound | Content (g) |
|---|---|---|
| Solvent | Water | 17.5 |
| Dispersion agent | 4,5-dihydroxy-1,3-benzenedisulfonic | 2 |
| | acid: Tiron | |
| Binder | polyvinyl alcohol | 9 |
| Plasticizer | polyethylene glycol | 6 |
| Defoaming agent | BYK-024 | 0.3 |
| Dispersion agent | BYK-346 | 0.3 |

### COMPARATIVE EXAMPLE 2

Barrier ribs are manufactured in the same way as the first comparative example, except that the thick film is hardened at 150° C. for 45 minutes in order to give tolerance against the solution (water) during the etching process, and then checked by a scanning electron microscope.

Different to the first comparative example, the barrier ribs of the second comparative example seldom have broken shapes, but does not maintain a perfect shape as much as the case of the first and second embodiments. In addition, because of using the separate semi-cross-linking process before etching, the manufacturing procedure is lengthened and therefore the manufacturing costs are increased.

Various changes and modifications within the spirit and scope of the invention will become apparent to those skilled in the art from this detailed description.

### Industrial Applicability

As described above, by the method of manufacturing barrier ribs for DPD and the composition for the method according to the present invention, it is possible to prevent conventional problems such as dust generation caused by the sand blasting and mechanical damage of barrier ribs since the thick film for forming the barrier ribs is etched with the use of water-based solution. In other words, it is possible to prevent environmental pollution, which may be generated during forming the barrier rib, by providing a pollution-free mechanical-chemical etching. In addition, since the mechanical etching and the chemical etching are applied together, it is possible to manufacture the fine pitch barrier ribs having a high width-length ratio, particularly barrier ribs having complex shapes such as a meander type. In case of forming the barrier rib forming thick film by laminating the green tape on the substrate, it is possible to improve productivity of the thick film for the barrier ribs and make the thick film quality uniform. As a result, the manufacturing method and the composition of the present invention may improve product reliability of the lower plate of PDP, production yield and quality uniformity, and the barrier rib shaping process used in the method may dramatically reduce the manufacture costs of the lower plate of PDP.

1. A method of manufacturing lower plate barrier ribs for a Plasma Display Panel (PDP) comprising the steps of:
forming a thick film (or, “green tape”) for barrier ribs on a glass or metal substrate by using composition for forming the barrier ribs, which contains water soluble components and solvent soluble components together as a binder;
forming a protective pattern film partially soluble or insoluble to the water soluble solution on the thick film;
etching the thick film into a barrier rib shape by using solution or mixed solution containing ceramic powder as an etching accelerator; and
sintering the etched thick film.

2. A method of manufacturing lower plate barrier ribs for PDP according to claim 1, wherein the method comprises the steps of:
(1) making a slurry by mixing glass powder and ceramic powder so that a mixing ratio is in the range between 50:50 and 95:5(volume ratio), and then mixing 20 to 40 wt % of solvent, 2 to 12 wt % of binder including water soluble components and solvent soluble components, 3 to 18 wt % of plasticizer and 0.5 to 2 wt % of dispersion agent and defoaming agent on the basis of 100 wt % of the mixed powder;
(2) making a thick film by coating the slurry of the glass or metal rear plate in the thickness of 5 to 200 μm, and then drying the coated slurry naturally or artificially under a predetermined temperature profile condition;
(3) forming the etching protective pattern film partially soluble or insoluble to the solution through printing or exposure, development and printing on the thick film formed on the glass or metal substrate;
(4) etching the thick film on which the protective pattern film is formed into a barrier rib shape by water-spraying the solution or the mixed solution in which the ceramic powder is included as etching accelerator; and
(5) removing the protective pattern film and then sintering the specimen at 450° C. to 600° C. for 0.5 to 1 hour.

3. A method of manufacturing lower plate barrier ribs for PDP according to claim 2, wherein the step (2) is executed by:
making the green tape by coating the slurry on a polymer carrier film in the thickness of 5 to 200 μm and then drying the coated slurry naturally or artificially under a predetermined temperature profile condition; and
making the thick film for barrier rib by laminating the green tape, formed on the polymer carrier film, on the glass or metal substrate.

4. A method of manufacturing rear plate barrier ribs for PDP according to claim 1,
wherein 0.5 to 10 wt % of surfactant and/or 0.5 to 10 wt % of wetting agent is added to the solution on the basis of water, which is solvent.

5. A method of manufacturing rear plate barrier ribs for PDP according to claim 1,
wherein the ceramic powder added to the mixed solution has an angled shape and an average particle size of 0.1 to 10 μm, and an added amount of the ceramic powder is 0 to 30 wt % on the basis of water, which is solvent.

6. Composition for manufacturing barrier ribs for a Plasma Display Panel (PDP) comprising:
(a) 100 wt % of mixture of glass powder and ceramic powder of which a volume ratio is in the range of 50:50 to 95:5;
(b) 20 to 40 wt % of solvent;
(c) 2 to 12 wt % of binder including water soluble components and solvent soluble components together;
(d) 3 to 18 wt % of plasticizer; and
(e) 0.5 to 2 wt % of dispersion agent and/or defoaming agent.

7. Composition for manufacturing barrier ribs for PDP according to claim 6,
wherein the glass powder has an average particle size of 0.1 to 10 μm and is selected from the group consisting of PbO—B₂O₃—SiO₂, P₂O₅—B₂O₃—SiO₂ and Bi₂O₃—B₂O₃—SiO₂ or their mixtures;
wherein the ceramic powder has an average particle size of 1 to 10 μm and is selected from the group consisting of Al₂O₃, fused silica, TiO₂ and ZnO₂, or their mixtures;
wherein the solvent is one solution or at least two mixed solution selected from the group consisting of methyl ethyl ketone (MEK), ethyl alcohol, isopropyl alcohol, toluene, xylene, tri-chloro ethylene, butanol, methanol, acetone, cyclohexanol, nitro-propane, propanol, N-propanol and water;
wherein the binder is a mixture of water soluble binder and solvent soluble binder having a volume ratio in the range of 20:1 to 1:20;
wherein the plasticizer is selected from the group consisting of diethyl oxalate, polyethylene, polyethylene glycol (PEG), dimethyl phthalate (DMP), dibutyl phthalate (DBP), diocyly phthalate (DOP), butyl benzyl phthalate, polyalkylene glycols, polypropylene glycol (PPG), tri-ethylene glycol, propylene carbonate, water and butyl stearate, or their mixture; and
wherein the dispersion agent is selected from the group consisting of menhaden fish oil, polyethyleneimine, glyceryl trioleate, polyacrylic acid, corn oil, polyisobutylene, linoleic acid, stearic acid, ammonium salt, salt acrylic acid, salt of poly acrylic acids, salt of methacrylic acids, linseed oil, glycerol triolate, sodium silicate, dibutylamine, ethoxylate, phosphate ester and 4,5-dihydroxy-1,3-benzenedisulfonic acid (Tiron).

8. Composition for manufacturing rear plate barrier ribs for PDP according to claim 7,
wherein the water soluble binder is selected from the group consisting of polyvinyl alcohol (PVA), hydroxyethyl cellulose (HEC), polyvinyl acetate (PVAc), polyvinyl pyrrolidine (PVP), methyl cellulose (MC), Hdroxypropylmethyl cellulose (HPMC), polypropylene carbonate, waxes, emulsion and latex, or their mixture, and has an average molecular weight of 5,000 to 300,000; and
wherein the solvent soluble binder is selected from the group consisting of cellulose, ethyl cellulose (EC), polyvinyl butyral (PVB), polymethyl methacrylate (PMMA), polyacrylate ester, polyvinyl pyrrolidine (PVP), polyvinyl chloride, polyethylene, polytetraflouroethylene (PTFE), poly-α -methyl styrene, polyisobutylene, polyurthane, nitro-cellulose and methyl methacrylate, or their mixture, and has an average molecular weight of 5,000 to 300,000.

9. A Plasma Display Panel (PDP) using the barrier ribs manufactured according to the method defined in the claim 1.
